(19) United States
(12) Patent Application Publication
(10) Pub. No.: US 2006/0133769 A1
(43) Pub. Date: Jun. 22, 2006

(54) Picture reproduction apparatus and picture reproduction method for continuously reproducing plurality of still-picture files

(75) Inventors: Shigeru Toji, Osaka (JP); Kayo Teramoto, Osaka (JP)

Correspondence Address: OSHA LIANG L.L.P., 1221 MCKINNEY STREET, SUITE 2800, HOUSTON, TX, 77010, US

(73) Assignee: Funai Electric Co., Ltd., Daito-shi (JP)

(21) Appl. No.: 11/283,346

(22) Filed: Nov. 18, 2005

(30) Foreign Application Priority Data
Dec. 16, 2004 (JP) 2004-364403

(51) Int. Cl. H04N 5/93; H04N 5/76; H04N 5/91

(52) U.S. Cl. 386/52; 715/723; 348/231.2; 386/46

(57) ABSTRACT

A user selects a still-picture file (JPEG11, JPEG22, JPEG37, . . . ) to be reproduced, from a list of still-picture file information. Then, the user sets a reproduction time period (7 seconds, 5 seconds, 2 seconds, . . . ), a start display effect (fade, wipe, dissolve, . . . ) and an end display effect (scroll, fade, cut, . . . ) for the selected still-picture file. In this manner, desired start display effect and end display effect for each still-picture file can individually be set, so that a plurality of still-picture files can continuously be reproduced in various display patterns, and a manner of reproduction preferred by the user can be realized.

### BACKGROUND OF THE INVENTION

1. Field of the Invention

The present invention relates to a picture reproduction apparatus and a picture reproduction method, and more particularly to a picture reproduction apparatus and a picture reproduction method for selectively reading a prescribed number of still-picture files from a recording medium on which a plurality of still-picture files are recorded and continuously reproducing the same.

2. Description of the Background Art

In a picture reproduction apparatus capable of continuous reproduction of a plurality of still-picture files such as a DVD (Digital Versatile Disc) player and a digital camera, a plurality of still-picture files are automatically continuously reproduced in accordance with a display time period and a variety of display effects (wipe, fade, scroll, and the like) that have been set in advance, so that various display patterns of the still-picture file can be achieved.

Japanese Utility Model Laying-Open No. 63-003682 discloses a picture recording and reproducing apparatus for an electronic camera capable of automatic, sequential reproduction of solely desired pictures for a desired time period. Here, numbers of pictures to be reproduced are recorded in order in advance, and the picture is automatically advanced in that order for each time period set in advance for each picture.

Japanese Patent Laying-Open No. 2004-128765 discloses a method of producing a variety of transition effects in continuous reproduction of still-pictures with a minimum amount of information. Here, a start transition effect and an end transition effect of the still-picture can be designated for a set of still-pictures including a plurality of pieces of information of still-pictures.

Though Japanese Utility Model Laying-Open No. 63-003682 discloses the method of setting a time period for displaying a picture, it does not disclose a method of setting a display effect of the picture. Meanwhile, the method disclosed in Japanese Patent Laying-Open No. 2004-128765 was not able to set a transition effect individually for each of a plurality of pictures included in the set of still-pictures. In addition, though the same start transition effect and the same end transition effect can be set in common to a plurality of pictures included in the set of still-pictures, the start transition effect and the end transition effect could not individually be set for each of the plurality of pictures.

### SUMMARY OF THE INVENTION

From the foregoing, a primary object of the present invention is to provide a picture reproduction apparatus and a picture reproduction method for allowing individual setting of a desired display effect for each of a plurality of still-picture files.

A picture reproduction apparatus according to the present invention selectively reads a prescribed number of still-picture files from a recording medium on which a plurality of still-picture files are recorded and continuously reproduces the same. The picture reproduction apparatus includes a setting portion and a control portion. The setting portion sets a reproduction time period for each of the prescribed number of still-picture files to be reproduced and a display effect for producing an effect when a picture makes a transition. The control portion continuously reproduces the prescribed number of still-picture files in accordance with the reproduction time period and the display effect set by the setting portion and causes the pictures to be displayed on a display.

Preferably, the display effect includes a start display effect for producing a display effect when display of each picture is started and an end display effect for producing a display effect when display of each picture ends.

According to a picture reproduction method of the present invention, a prescribed number of still-picture files are selectively read from a recording medium on which a plurality of still-picture files are recorded, and continuously reproduced. The method includes the steps of: setting a reproduction time period for each of the prescribed number of still-picture files to be reproduced and a display effect for producing an effect when a picture makes a transition; and continuously reproducing the prescribed number of still-picture files in accordance with the reproduction time period and the display effect that have been set and causing the pictures to be displayed on a display.

Therefore, a primary advantage of the present invention is that a desired display effect can individually be set for each of the plurality of still-picture files to be reproduced. A plurality of still-picture files can thus continuously be reproduced in various display patterns, and a manner of reproduction preferred by a user can be realized.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing a schematic configuration of a picture reproduction apparatus according to one embodiment of the present invention.

FIG. 2 shows a screen for setting a table for reproduction displayed on a display shown in FIG. 1.

FIG. 3 is a flowchart showing a procedure for setting the table for reproduction.

FIG. 4 shows pictures continuously displayed on the display.

### DESCRIPTION OF THE PREFERRED EMBODIMENTS

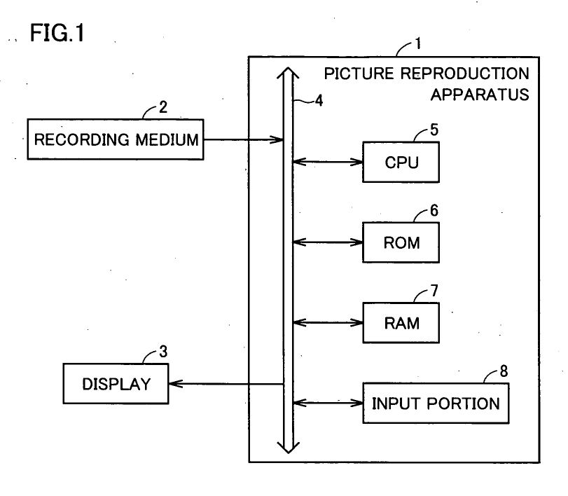

In FIG. 1, a picture reproduction apparatus 1 includes an internal bus 4, a CPU (Central Processing Unit) 5, an ROM (Read Only Memory) 6, an RAM (Random Access Memory) 7, and an input portion 8.

In picture reproduction apparatus 1, ROM 6, RAM 7 and input portion 8 are connected to CPU 5 through internal bus 4. CPU 5 controls an overall operation of picture reproduction apparatus 1. A recording medium 2 is represented, for example, by a DVD and a CD (Compact Disc), and records a plurality of still-picture files (such as JPEG (Joint Photographic Experts Group) files). Picture reproduction apparatus 1 can select a still-picture file to be reproduced, from the plurality of still-picture files recorded on recording medium 2, and causes a display 3 to continuously display pictures of the selected still-picture files. Recording medium 2 can also record a music file such as MP3 (MPEG Audio Layer-3) in addition to the still-picture file, and picture reproduction apparatus 1 can also reproduce a still-picture file in synchronization with reproduction of a music file.

ROM 6 is a read-only semiconductor memory for storing a control program for controlling an operation of picture reproduction apparatus 1. RAM 7 is a readable and writable semiconductor memory for storing a table for reproduction for setting a reproduction time period of a still-picture file to be reproduced among the plurality of still-picture files recorded on recording medium 2, a display effect for producing an effect when a picture of the still-picture file makes a transition, and the like. The user performs a variety of operations of picture reproduction apparatus 1, such as setting of the table for reproduction, through input portion 8. Display 3 displays a screen for setting the table for reproduction and a picture of the still-picture file. CPU 5 and ROM 6 constitute the control portion, while RAM 7 and input portion 8 constitute the setting portion.

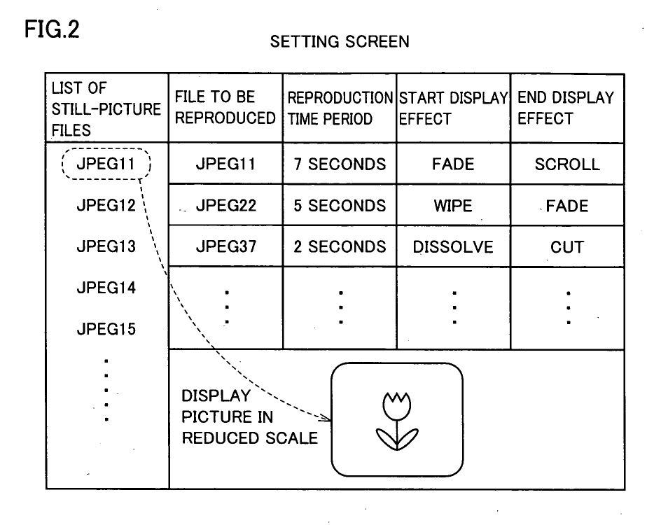

FIG. 2 shows the screen for setting the table for reproduction displayed on display 3 shown in FIG. 1. Referring to FIG. 2, initially, a list of still-picture file information (JPEG11, JPEG12, JPEG13, . . . ) read from recording medium 2 is displayed in a pull-down menu on the screen for setting the table for reproduction. The user selects a still-picture file (JPEG11, JPEG22, JPEG37, . . . ) to be reproduced from the list of the still-picture file information. Here, any still-picture file (for example, JPEG11) from the list of the still-picture file information can be displayed in a reduced scale in a lower portion of the setting screen, so that the user selects a still-picture file (JPEG11, JPEG22, JPEG37, . . . ) to be reproduced while referring to the picture displayed in a reduced scale. Then, the user sets a reproduction time period (7 seconds, 5 seconds, 2 seconds, . . . ), a start display effect (fade, wipe, dissolve, . . . ) and an end display effect (scroll, fade, cut, . . . ) for the selected still-picture file.

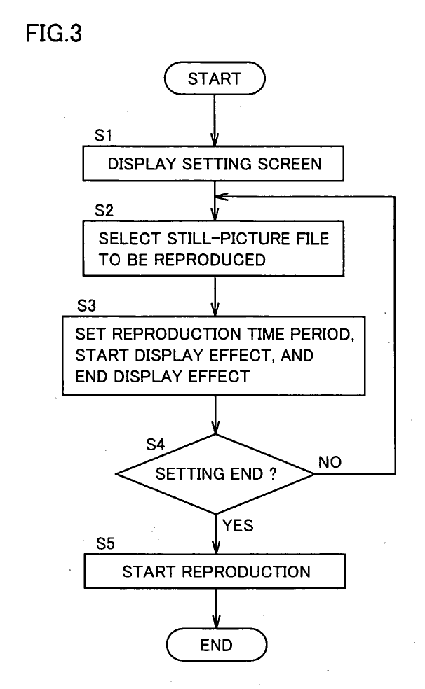

FIG. 3 is a flowchart showing a procedure for setting the table for reproduction. Referring to FIG. 3, when the user instructs display of the screen for setting the table for reproduction through input portion 8 at step S1, CPU 5 causes display 3 to display the screen for setting the table for reproduction. In the setting screen, a list of still-picture file information (JPEG11, JPEG12, JPEG13, . . . ) read from recording medium 2 is displayed in a pull-down menu.

Then, at step S2, the user selects a still-picture file (for example, JPEG11) to be reproduced in the first place, from the list of the still-picture file information. Thereafter, at step S3, a reproduction time period (for example, 7 seconds), a start display effect (for example, fade) and an end display effect (for example, scroll) for the selected still-picture file are set.

Then, if the setting is not yet completed at step S4 (NO), the process returns to step S2, and the user selects a still-picture file to be reproduced in the second place (for example, JPEG22). Thereafter, the similar operation from step S2 to step S4 is repeated. When the setting of still-picture files to be reproduced is completed (YES), the process proceeds to step S5. At step S5, solely the selected still-picture files (JPEG11, JPEG22, JPEG37, . . . ) are continuously reproduced in accordance with the table for reproduction that has been set, in response to an instruction to reproduce the still-picture file, and these pictures are continuously displayed on display 3.

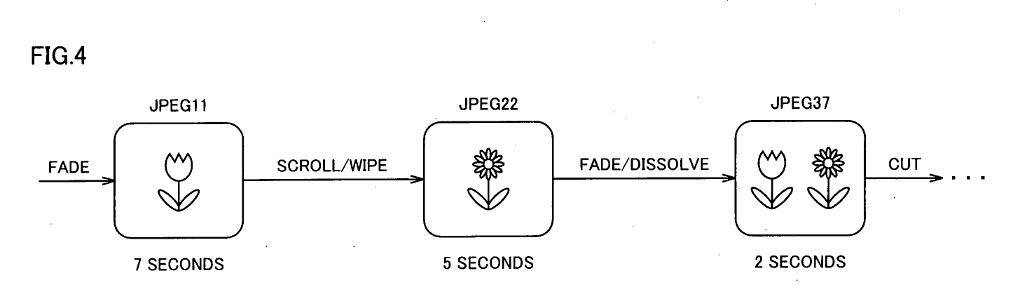

FIG. 4 shows pictures continuously displayed on display 3. Referring to FIG. 4, the picture of the first still-picture file (JPEG11) is displayed with the start display effect (fade) that has been set, in accordance with the table for reproduction. After the reproduction time period (7 seconds) that has been set elapses, the picture display ends with the end display effect (scroll) that has been set. In succession, the picture of the second still-picture file (JPEG22) is displayed with the start display effect (wipe) that has been set. After the reproduction time period (5 seconds) that has been set elapses, the picture display ends with the end display effect (fade) that has been set. In succession, the picture of the third still-picture file (JPEG37) is displayed with the start display effect (dissolve) that has been set. After the reproduction time period (2 seconds) that has been set elapses, the picture display ends with the end display effect (cut) that has been set. In this manner, solely the still-picture files to be reproduced are automatically continuously reproduced in accordance with the display time period, the start display effect and the end display effect that have been set in the table for reproduction, and the pictures are continuously displayed on display 3.

Therefore, in this embodiment, a desired display effect can individually be set for each of the plurality of still-picture files. In addition, desired start display effect and end display effect can individually be set for each of the plurality of still-picture files, so that a plurality of still-picture files can continuously be reproduced in various display patterns, and a manner of reproduction preferred by the user can be realized. Moreover, any still-picture file from the list of still-picture file information read from the recording medium is displayed in a reduced scale in the lower portion of the setting screen, so that the user can select a still-picture file to be reproduced while referring to the picture displayed in the reduced scale. Namely, operability is excellent.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A picture reproduction apparatus for selectively reading a prescribed number of still-picture files from a recording medium on which a plurality of still-picture files are recorded and continuously reproducing the same, comprising:
setting means for setting a reproduction time period for each of said prescribed number of still-picture files to be reproduced and a display effect for producing an effect when each picture makes a transition; and
control means for continuously reproducing said prescribed number of still-picture files in accordance with the reproduction time period and the display effect set by said setting means and causing pictures to be displayed on a display.

2. The picture reproduction apparatus according to claim 1, wherein
said display effect includes a start display effect for producing a display effect when display of each picture is started and an end display effect for producing a display effect when display of each picture ends.

3. A picture reproduction method for selectively reading a prescribed number of still-picture files from a recording medium on which a plurality of still-picture files are recorded and continuously reproducing the same, comprising the steps of:
setting a reproduction time period for each of said prescribed number of still-picture files to be reproduced and a display effect for producing an effect when each picture makes a transition; and
continuously reproducing said prescribed number of still-picture files in accordance with the reproduction time period and display effect that have been set and causing pictures to be displayed on a display.

4. The picture reproduction method according to claim 3, wherein
said display effect includes a start display effect for producing a display effect when display of each picture is started and an end display effect for producing a display effect when display of each picture ends.
